(19) United States
(12) Patent Application Publication
(10) Pub. No.: US 2026/0070194 A1
(43) Pub. Date: Mar. 12, 2026

(54) RATCHET DRIVER

(71) Applicant: Fiskars Brands, Inc., Middleton, WI (US)

(72) Inventor: Matt Rauwerdink, Newberg, OR (US)

(73) Assignee: Fiskars Brands, Inc., Middleton, WI (US)

(21) Appl. No.: 19/106,888

(22) PCT Filed: Aug. 24, 2023
(86) PCT No.: PCT/US2023/031042

§ 371 Date: Feb. 26, 2025

Related U.S. Application Data
(60) Provisional application No. 63/401,425, filed on Aug. 26, 2022.

(51) Int. Cl. B25B 15/04; B25F 1/00; B25G 1/08

(52) U.S. Cl. CPC B25B 15/04; B25F 1/003; B25G 1/085

(57) ABSTRACT

A hand tool includes a handle including an opening at a first end of the handle, the opening extending into the handle and a first group of projections positioned within the opening, a driver positioned within the opening and including a second group of projections configured to interface with the first group of projections. The driver is configured to translate along an axis between a first position. The first group of projections interface with the second group of projections while the driver is in the first position to prevent the driver from rotating about the axis. The driver is configured to rotate about the axis while the driver is in the second position. A spring is positioned within the opening and configured to bias the driver towards the second position.

### CROSS-REFERENCE TO RELATED APPLICATION

The present application is a national stage filing of PCT Application No. PCT/US2023/031042, filed Aug. 24, 2023, which claims the benefit of and priority to U.S. Provisional Application No. 63/401,425, filed Aug. 26, 2022, each of which are incorporated herein by reference in their entirety.

### TECHNICAL FIELD

The present disclosure relates generally to hand tools, and more specifically, to hand tools including a ratcheting driver.

### BACKGROUND

Ratcheting drivers typically include a mechanism that permits a tool to apply turning force only in one direction (e.g., the ratcheting direction). The ratcheting direction can be set to tighten or loosen fasteners without having to disengage the tip of the driver with the head of the fastener at the end of each partial turn.

### SUMMARY

According to various embodiments, a hand tool includes a handle including an opening at a first end of the handle, the opening extending into the handle, and a first group of projections positioned within the opening. A driver is positioned within the opening and includes a second group of projections configured to interface with the first group of projections, wherein the driver is configured to translate along an axis between a first position, wherein the first group of projections interface with the second group of projections while the driver is in the first position such that the driver is prevented from rotating relative to the handle about the axis, and a second position, wherein the driver is configured to rotate about the axis while the driver is in the second position, and a spring positioned within the opening and configured to bias the driver towards the second position.

In some embodiments, the hand tool further includes a stopper extending into the opening and configured to engage a shoulder of the driver while the driver is in the second position and prevent the driver from extending beyond the second position. In some embodiments, the stopper extends into the opening in a direction perpendicular to the axis. In some embodiments, the shoulder is a first shoulder and the stopper is configured to engage a second shoulder in the driver and prevent the driver from extending beyond the second position. In some embodiments, the driver includes a part opening configured to receive a bit. In some embodiments, the driver includes a bit at an end of the driver opposite the second group of projections. In some embodiments, the first group of projections are integrally formed within the handle. In some embodiments, the opening is a first opening and the handle includes a second opening extending into the first opening, the second opening being positioned between the first group of projections and the first opening. In some embodiments, the second group of projections are exposed via the second opening while the driver is in the second position.

According to various embodiments, a ratcheting mechanism includes a body including an opening at a first end of the body, the opening extending into the body to define a cavity, and a first projection positioned within the cavity opposite the first end of the body. The ratcheting mechanism also includes a driver positioned within the cavity and including a second projection configured to interface with the first projection, wherein the driver is configured to translate between: a first position, wherein the first position interfaces with the second projection while the driver is in the first position such that the driver is prevented from rotating within the cavity with respect to the body, and a second position, wherein the driver is configured to rotate within the cavity with respect to the body while the driver is in the second position. The ratcheting mechanism also includes a spring positioned within the cavity and configured to bias the driver towards the second position.

In some embodiments, the body of the ratcheting mechanism is integrally formed within a handle of a hand tool. In some embodiments, the body includes a first group of projections, including the first projection, and the driver includes a second group of projections, including the second projection. In some embodiments, the first projection includes a first sidewall and a second sidewall that converge to a point and define a tooth angle. In some embodiments, the tooth angle is between 80 degrees and 100 degrees. In some embodiments, the first projection is fixed relative to the body.

According to various embodiments, a tool includes a handle including an opening at a first end of the handle, the opening extending into the handle to define a cavity, and a first group of projections positioned within the cavity opposite the first end of the handle. The tool also includes a driver positioned within the cavity and including a second group of projections configured to interface with the first group of projections, wherein the driver is configured to translate between: a first position, wherein the first group of projections interface with the second group of projections while the driver is in the first position such that the driver is prevented from rotating in a first direction within the cavity with respect to the handle, and a second position, wherein the driver is configured to rotate in the first direction within the cavity with respect to the handle while the driver is in the second position.

In some embodiments, the first group of projections are fixed relative to the handle. In some embodiments, the driver is prevented from rotating in a second direction, opposite the first direction, while the driver is in the first position. In some embodiments, the driver is configured to rotate in the second direction while the driver is in the second position. In some embodiments, the driver is biased towards the second position.

### BRIEF DESCRIPTION OF THE FIGURES

The invention will become more fully understood from the following detailed description, taken in conjunction with the accompanying drawings, in which:

FIG. 1 is a side view of a hand tool, according to an exemplary embodiment.

FIG. 2 is an exploded side view of the hand tool of FIG. 1.

FIG. 3 is a cross-sectional view of a driver in a disengaged position within a handle of the hand tool of FIG. 1.

FIG. 4 is a partial view of the driver in the disengaged position within the handle of the hand tool of FIG. 1.

FIG. 5 is another partial side view of the driver in the disengaged position within the handle of the hand tool of FIG. 1.

FIG. 6 is another cross-sectional view of a driver in a disengaged position within a handle of the hand tool of FIG. 1.

FIG. 7 is a cross-sectional view of the driver in an engaged position within the handle of the hand tool of FIG. 1.

FIG. 8 is a partial view of the driver in the engaged position within the handle of the hand tool of FIG. 1.

FIG. 9 is a side view of the driver in the engaged position within the handle of the hand tool of FIG. 1.

FIG. 10 is a side view of the handle of the hand tool of FIG. 1.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Many types of fasteners, such as screws, need to be rotationally driven to be loosened or tightened. For example, a driver (e.g., a Philips screw driver, a torx screw driver, an insulated screw driver, a torque screw driver, a flathead screw driver, a tri-wing screw driver, a pozidriv screwdriver, a hex screw driver, etc.) may be used to drive a fastener to tighten or loosen the fastener. Accordingly, a hand tool may include a driver configured to rotationally drive a fastener.

According to various examples, a fastener may be in a difficult to reach position. For example, when using a driver to rotate the fastener, various obstructions may prevent the hand tool and/or a driver from making one or more full rotations. In another example situation, a relatively large torque may need to be applied to the fastener to tighten or loosen the fastener. In this situation, a user of the driver may only be able to generate sufficient torque if the user's wrist is in a certain orientation, thereby preventing the user from causing the driver to rotate a full rotation.

In these examples, an operator of the driver may only be able to make a partial rotation (e.g., quarter, eighth, etc.) before the user is required to remove the tip of the driver from the head of the fastener, reset his or her hand position, and re-engage the tip of the driver with the head before making another partial turn. Repeatedly engaging and disengaging the tip of the driver with the head of the fastener can be a time consuming and inefficient process.

According to various embodiments described herein, a driver is disclosed. The driver is configured to translate within a housing between a disengaged position and an engaged position. When the driver is in the disengaged position, the driver may rotate within the housing (e.g., base portion, handle, etc.) such that the housing may be rotated independently of the driver. For example, rotation of the handle when the driver is in the disengaged position may not transfer sufficient torque (e.g., no torque, below a minimum threshold torque, etc.) from the handle to the driver to cause the fastener to tighten or loosen.

While the driver is in the engaged position, the driver may be prevented from rotating within the housing such that the rotation of the housing causes rotation of the driver. For example, when the driver is in the engaged position, torque may be transferred from the handle to the driver to tighten or loosen a fastener using the driver. Accordingly, a user of the driver may engage and disengage the driver within the housing to selectively drive (e.g., tighten or loosen) the fastener without disengaging the tip of the driver from the fastener. For example, if a fastener is in a difficult to reach place, a user of the driver may engage the driver with the housing to complete a partial turn to tighten or loosen a fastener and disengage the driver with the housing to rotate the housing back a partial turn without tightening or loosening the fastener. In this scenario, the user of the driver is not required disengage the tip of the driver from the head of the fastener to reposition the housing at the end of each partial turn. By keeping the tip of the driver engaged with the fastener, the fastener may be tightened or loosened faster and more efficiently than repeatedly engaging and disengaging the tip of the driver with the head of the fastener.

According to various embodiments, the driver disclosed herein may engage and disengage with the housing in response to a lateral force (e.g., a minimum threshold force) being applied to the driver (e.g., along the axis of rotation of the driver). For example, a biasing member may bias the driver towards the disengaged position. A user of the driver may cause the driver to engage the housing by pushing (e.g., applying a force larger than a minimum threshold force needed to overcome the biasing member) the housing towards a fastener while the tip of the driver is engaged with the head of the fastener.

Unlike other ratcheting drivers, which may utilize a toggle switch to set a ratcheting direction (e.g., clockwise or counterclockwise), a user of the driver described herein does not need to toggle a switch, thereby simplifying the engagement mechanism. According to various embodiments, this may facilitate single handed use of the driver and enable a user to easily change ratcheting directions while the tip of the driver is in contact with the head of the fastener. For example, by pressing downward to the fastener, the driver becomes coupled to the housing for rotation of the driver and by releasing the downward force, the driver rotates independently within the housing allowing the housing to be positioned for another press (e.g., engagement of the driver and the housing) and turn of the fastener.

Further, eliminating the need to a toggle switch allows the driver to have a smaller footprint and less moving parts. Thus, the driver mechanism can be made compact and allow the user to easily switch between clockwise and counter-clockwise modes of use. According to various embodiments, the driver is biased away from the handle engagement (e.g., biased towards the disengaged position) by a small spring.

Referring now to the FIGURES generally, a tool is disclosed. The tool includes a handle (e.g., a housing) defining an opening that extends into the handle to create a cavity, and a driver positioned concentrically within the opening that extends into the cavity, along an axis of rotation. The side of the handle that defines the end of the cavity opposite the opening includes one or more projections extending down into the cavity. A first end of the driver has projections that are configured to engage with the projections within the handle.

According to various embodiments, the driver is configured to translate within the cavity such that the driver moves between an engaged position (e.g., a first position), in which the handle projections and driver projections are engaged, and a disengaged position (e.g., a second position), in which the handle projections are not engaged with the projections within the cavity such that the driver is configured to rotate independently of the handle.

According to various embodiments, the tool includes a stopper assembly. According to various embodiments, the stopper assembly includes an opening in one side of the handle that extends into the cavity and a stopper (e.g., a set screw) at least partially positioned within the opening and extending into the cavity in a direction perpendicular to the axis of rotation. According to various embodiments, the driver includes a cutout section having a first diameter between two wider portions having a second diameter that is larger than the first diameter such that a first shoulder and a second shoulder are formed at each end of the cutout section. The stopper is configured to contact at least one of the first shoulder or the second shoulder of the driver to limit the distance the driver translates within the housing. According to various embodiments, a biasing mechanism biases the driver in towards the disengaged position (e.g., a second position).

According to various embodiments, the driver further includes an opening at a second end opposite the projections. The opening defines a cavity and is configured to receive one or more tool bits. For example, a user of the tool may be able to select a particular tool bit (e.g., hex head, flat head, etc.) and insert the tool bit into the opening such that the tool bit may be used to tighten or loosen a fastener. According to various embodiments, a magnet is positioned in the cavity of the driver so that it may secure a metal tool bit within the cavity.

According to some embodiments, the tool includes a biasing member configured to bias the driver towards the disengaged position. According to various embodiments, the biasing mechanism includes a spring positioned between the handle and driver. According to various embodiments, a minimum threshold force is needed to overcome the biasing force applied by the biasing mechanism. For example, when a user pushes (e.g., using a force greater than the minimum threshold force) the handle towards a fastener while the driver is engaged with the fastener, the driver will translate from the disengaged position to the engaged position such that the projections within the handle engage with the projection on the end of the driver such that torque may be transferred from the handle to the driver to loosen or tighten a fastener.

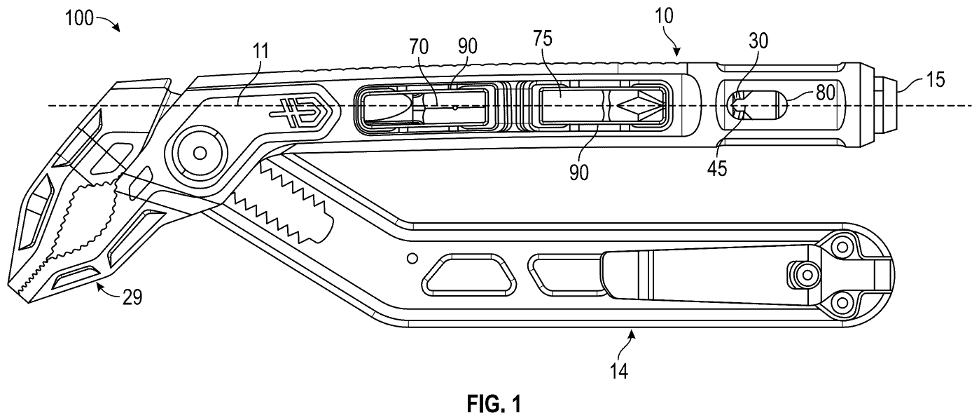

Referring now to FIG. 1, a side view of a hand tool 100 is shown, according to an exemplary embodiment. The hand tool 100 includes a handle 10 (e.g., a first handle) that extends along a first axis 11. The handle 10 includes a plurality of cavities that define first and second bit compartments 90 configured to secure one or more tool bits within the bit compartments 90. For example, tool bits 70, 75 are secured within bit compartments 90 such that a user of the hand tool 100 may remove a desired tool bit from the bit compartments 90. The first tool bit 70 and the second tool bit may be any type of tool bit, such as a Philips screw bit, a torx screw bit, r, a torque screw bit, a flathead screw bit, a tri-wing screw bit, a pozidriv bit, a hex screw bit, etc.

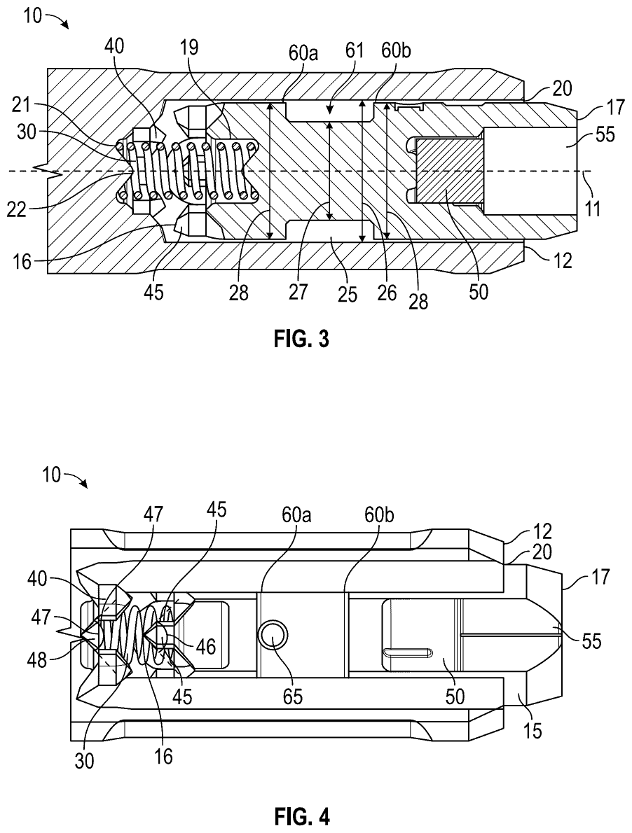

As shown, the hand tool 100 includes a driver 15 positioned within an opening in the handle 10 (e.g., opening 20 shown in FIG. 3). The driver 15 is configured to translate within the handle 10 between at least an engaged position and a disengaged position. As will be discussed further herein, the driver 15 may rotate (e.g., about the first axis 11) relative to the handle 10 when the driver 15 is in the disengaged position. Further, the driver 15 may be prevented from rotating relative to the handle 10 when the driver 15 is in the engage position. As shown, the handle 10 includes an opening that defines a window 80 such that at least a portion of the driver 15 is exposed via the window 80 within the handle 10. According to various embodiments, the hand tool 100 includes a plurality of openings that define a plurality of windows 80 surrounding at least a portion of the driver 15 such that a portion of the driver 15 is at least partially exposed vid the plurality of windows 80. According to various embodiments, the window 80 may provide axis to the cavity within the handle 10 between the projections 45 of the driver and the projections within the handle 10. According to various embodiments, the window 80 allows a user of the hand tool 100 to clean out the cavity within the handle 10. For example, unwanted debris may be introduced into the cavity during use and may reduce the effectiveness of the driver ratcheting mechanism described herein. As such, the window 80 enables the user to clean out the unwanted debris without needing to remove the driver 15 from the cavity in the handle 10.

As shown, the driver 15 includes a plurality of driver projections 45 configured to engage one or more projection positioned within the handle 10, as is discussed further below. For example, when the driver 15 is in the engaged positioned, the plurality of projections 45 may interface with a plurality of projections within the handle 10 to prevent the driver 15 from rotating within the handle 10, as is discussed further herein.

Further, the hand tool 100 includes a spring 30 positioned within the cavity in the handle 10 proximate the driver 15. The spring 30 is configured to bias the driver 15 towards the disengaged position. According to various embodiments, the spring 30 is at least partially exposed via the window 80. The driver 15 moves between an engaged (e.g., first) position and a disengaged (e.g., second) position. The spring 30 biases the driver 15 towards the disengaged position.

According to various embodiments, a minimum threshold force is required to overcome the biasing force provided by the spring 30. For example, the driver 15 may be coupled to a bit 75 that is configured to drive a fastener. In use, the user may grasp the handle 10, engage the bit 75 with the fastener, and apply a force to the handle (e.g., pushing the handle 10 towards the fastener along the axis 11) greater than the minimum threshold force, which will cause the driver 15 to translate within the handle 10 along the axis 11 from the disengaged to the engaged position. When the driver 15 is in the engaged position, the user may rotate the handle 10 in a desired direction (e.g., about the axis 11), which will in turn cause the driver 15 and the bit 75 to rotate and drive the fastener. The driver 15 will remain in the engaged position so long as the user continues to apply a force to the handle 10 greater than the minimum threshold force. Once the user applies less than the minimum threshold force to the handle 10, the spring 30 will cause the driver to translate about the axis 11 back to the disengaged position. When the driver 15 is in the disengaged position, the handle 10 may rotate independently of the driver 15 and the bit 75 such that the user may rotate the handle 10 (e.g., while the bit 75 is engaged with the fastener) without driving the fastener.

As shown, hand tool 100 includes a pliers 29 (e.g., a tongue and groove pliers) opposite of the driver 15. The handle 10 (e.g., a first handle) is rotatably coupled to a second handle 14 such that a user may control the pliers 29 using the first handle 10 and the second handle 14. While the hand tool 100 is shown to include a pliers 29, it should be appreciated that the ratcheting driver mechanism described herein may be utilized in any number of hand tools. For example, the ratcheting driver mechanism may be used in the shaft of a screw driver, in the handle of a screw driver, in the handle of a hammer, in the handle of a wrench, in the handle of a utility knife, in the handle of a multi-tool, in the handle of a flashlight, etc. Further, the ratcheting driver mechanism described herein may be positioned within a body or housing such that the ratcheting driver mechanism may be deployed from within the hand tool. For example, the ratcheting driver mechanism may be positioned within a body that is rotatably coupled to the hand tool (e.g., as a part of a multi-tool) such that the driver 15 may be stowed within the hand tool and deployed for use.

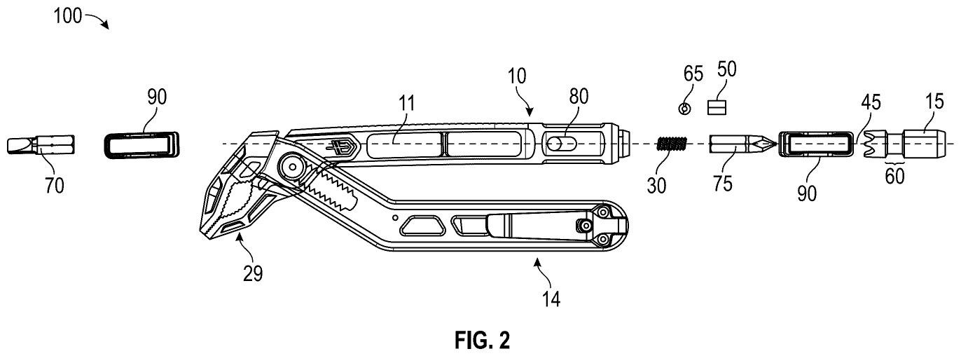

Referring now to FIG. 2, an exploded side view of the hand tool 100 of FIG. 1 is shown, according to an exemplary embodiment. As discussed above, handle 10 of hand tool 100 includes a plurality of cavities that define bit compartments 90 configured to secure tool bits 70, 75 within the handle 10. The handle 10 further includes the window 80 through which driver 15 is exposed. As is discussed further herein, the hand tool 100 includes a stopper 65 that is configured to be positioned at least partially within the opening 64 such that a portion of the stopper 65 extends perpendicularly to the axis of rotation of the driver 15. The driver 15 also includes a magnet 50 and shoulders 60a, 60b, the functions of which are described herein.

Referring now to FIGS. 3-6, the driver 15 is shown in the disengaged position, according to an example embodiment. As shown, the handle 10 includes an opening 20 proximate a first end 12 of the handle 10. The opening 20 extends into the handle 10 and terminates at an end 21 of the opening 20 to define a cavity 25 having a cavity diameter 26. The spring 30 is positioned between the end 21 of the handle and driver 15 and is configured to bias the driver 15 towards the disengaged position.

As shown, the handle 10 includes a centering projection 22 protruding from the end 21 of the opening 20 along a center axis of rotation (e.g., the first axis 11). The centering projection 22 is configured to engage the spring 30, such that at least a portion of the spring 30 is centered along the axis 11. Further, the driver 15 includes a centering projection 18 positioned within a cavity 19 in the driver 15. As shown, a portion of the spring 30 is positioned within the cavity 19 and a portion of the centering projection 18 is positioned within the spring. The centering projection 22 in the handle 10, the centering projection 18 in the driver 15, and the cavity 19 in the driver 15 may each facilitate centering the spring 30 along the axis 11.

According to various embodiments, the spring 30 is configured to bias the driver 15 towards the disengaged position. Further, the handle 10 includes a plurality of projections 40 positioned within the cavity 25 opposite opening 20. As shown, the projections 40 extend from handle 10 into cavity 25. According to various embodiments, the projections 40 are configured to engage with the projections 45 of the driver 15 to selectively prevent the driver 15 from rotating within the cavity 25 relative to the handle 10 (e.g., while the driver 15 is in the engaged position). For example, as shown, the driver 15 is positioned within cavity 25 such that the driver 15 extends along the axis 11. A first end 16 of the driver 15 is located proximate the end 21 of the opening 20 of the handle 10 and includes a plurality of projections 45 that are configured to engage with handle projections 40 while the driver 15 is in the engaged position.

As shown in FIGS. 3, 5, and 6, the driver 15 defines a cutout section 61 extending along the axis 11 and having a first diameter 27. As shown, the cutout section 61 is positioned between two portions having a second diameter 28 that is larger than the first diameter 27. As such, that the driver 15 includes a first shoulder 60a and a second shoulder 60b that are located proximate the ends of the cutout section 61.

Further, as is shown in FIG. 6, the hand tool 100 includes a stopper 65 (e.g., a set screw) configured to engage at least one of the first shoulder 60a and the second shoulder 60b to limits the distance the driver 15 travels within the handle 10. According to various embodiments, the stopper 65 interfaces with the shoulder 60a of driver 15 when the driver is in the disengaged position (e.g., as shown in FIG. 6). Be engaging the shoulder 60a, the stopper 65 limits the distance the driver 15 is able to translate and prevents driver 15 from moving further or completely out of the cavity 25. According to various embodiments, the stopper 65 interfaces with the shoulder 60b of driver 15 when the driver is in the engaged position. Accordingly, the stopper 65 is configured to limit the distance the driver 15 is able translate within the handle 10 and prevents driver 15 from translating along the axis 11 further into the cavity 25, which may prevent damage to the projections 45 if excessive force is applied to the driver 15 along the axis 11.

As shown in FIGS. 3 and 6, an opening on a second end 17 of driver 15 extends into the driver such that a bit cavity 55 is defined. The bit cavity 55 is configured to receive one or more bits (e.g., the first bit 70, the second bit 75, etc.) such that torque may be transferred from the driver 15 to the bit secured within the driver 15. According to various embodiments, the bit cavity 55 is hexagonal shaped, such that the bit cavity 55 is configured to receive and drive bits having a hexagonal shape. According to various embodiments, a magnet 50 is positioned within the cavity 55. According to various embodiments, the magnet 50 is configured to selectively secure a bit within the bit cavity 55. For example, one of the tool bits 70, 75 may be inserted into the cavity 55 such that a first end of the bit is magnetically coupled to magnet 50 to secure the bit in place and the second end of the bit may be used to drive a fastener.

As shown in FIG. 4, each of the driver projections 45 define a driver projection angle 46. According to various embodiments, driver projection angle 46 is between 80 degrees and 100 degrees. Additionally, the driver slots 48 between the handle projections 40 (e.g., the openings configured to receive the driver projections 45 when the driver is in the engaged position) define a corresponding driver slot angle 47. According to various embodiments, the driver slot angle 49 is between 80 degrees and 100 degrees. When driver 15 is in the disengaged position, the driver projections 45 are not engaged with the driver slots 48 such that the driver 15 may rotate within the cavity 25 relative to the handle 10.

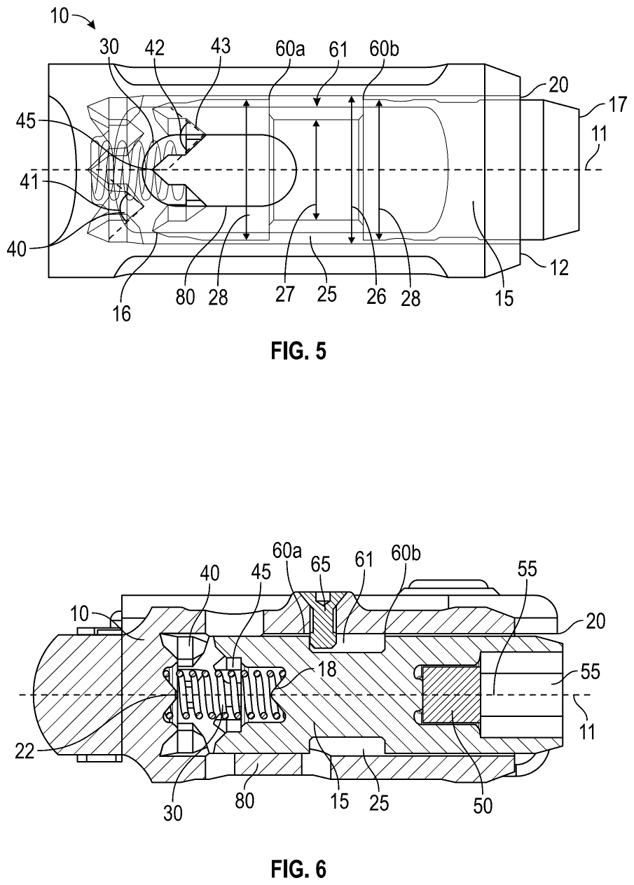

As shown in FIG. 5, each of the handle projections 40 define a handle projection angle 41. According to various embodiments, the handle projection angle 41 is between 80 degrees and 100 degrees. As shown, the handle 10 includes corresponding handle projection slots 43 on driver 15. The handle projection slots 43 each define a handle slot angle 42. In some embodiments, handle slot angle is between 80 degrees and 100 degrees.

As is discussed further herein, when the driver projections 45 are received within the corresponding driver slots 48 and the handle projections 40 are received within the corresponding handle projection slots 43 (e.g., the driver 15 is in the engaged position), the interaction between the projections and the slots prevent the driver 15 from rotating within the handle 10 such that the driver 15 may be used to drive a fastener. According to various embodiments, the driver 15 is prevented from rotating in a first direction (e.g., clockwise) and a second direction (e.g., counterclockwise) relative to the handle 10 while the driver 15 is in the engaged position. However, according to alternative embodiments, the driver 15 may only be prevented from rotating in the first direction relative to the handle 10, and free to rotate in the second direction relative to the handle 10, while the driver is in the engaged position. For example, the handle projections 40 and/or the driver projections 45 may not come to a point, as shown in FIG. 5. Rather, the handle projections 40 and/or the driver projections 45 may include a sloped surface that prevents rotation of the driver 15 in a first direction while allowing the driver 15 to rotate in the second direction while the driver 15 is in the engaged position.

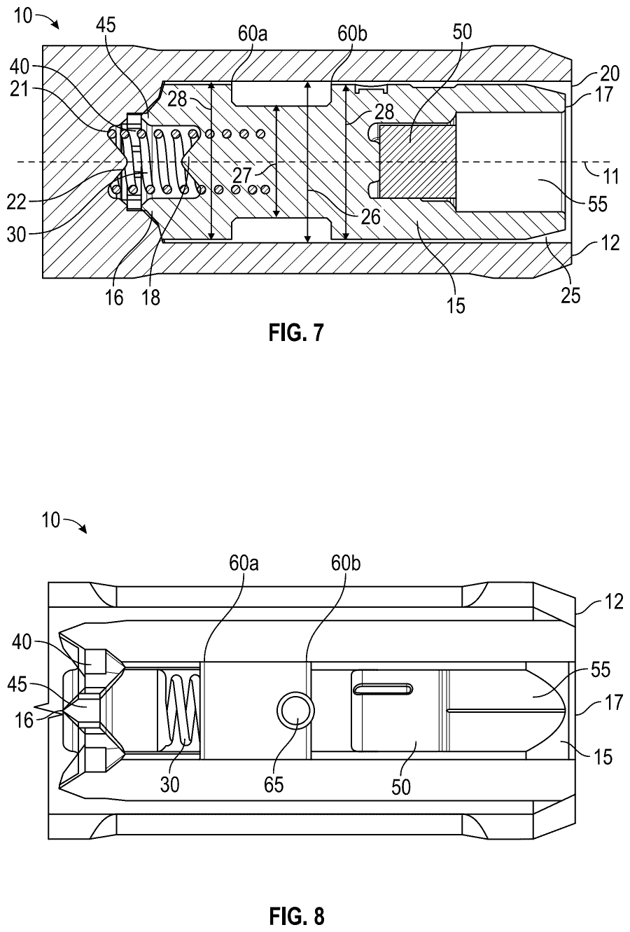

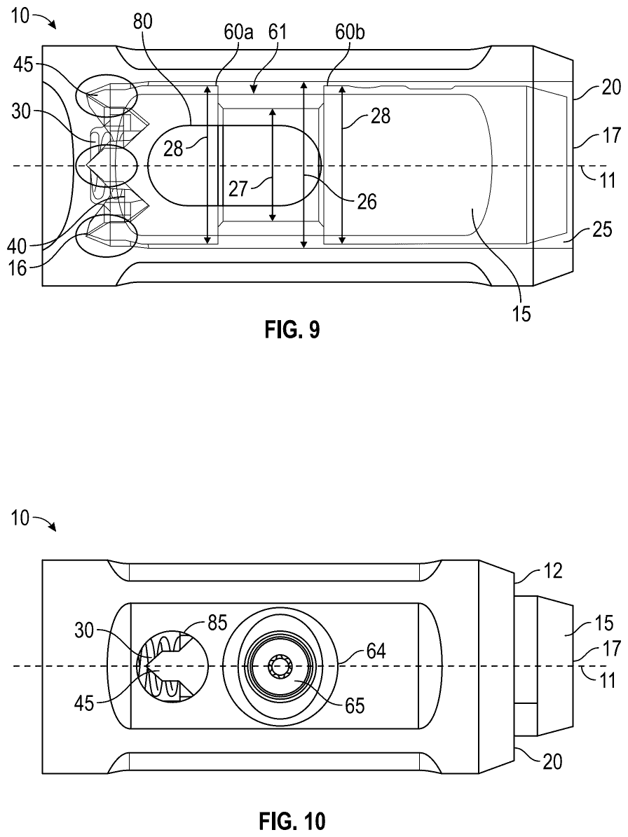

Referring now to FIGS. 7-9, the driver 15 is shown within the handle 10 in the engaged position. According to various embodiments, a minimum threshold force must be met to overcome the biasing force applied by the biasing mechanism (e.g., the spring force applied by spring 30) to cause the driver 15 to translate from the disengaged position to the engaged position. When a force is applied to the driver 15 (e.g., along the axis 11) that overcomes the biasing force, the driver will translate from the disengaged position to the engaged position. When in the engaged position, the handle projections 40 engaged the driver projections 45 such that torque may be transferred from the handle 10 (e.g., as applied by a user of the hand tool 100) to the driver 15 to drive (e.g., loosen or tighten) a fastener (e.g., a fastener engaged with the head of tool bit 70, 75 extending out from cavity 55).

Referring now to FIG. 10, a side view of driver 15 in the disengaged position within handle 10. As shown, the head of stopper 65 is at least partially positioned within the opening 64. As shown, the driver projections 45 are visible through a second window 85 of handle 10. The second window 85 is positioned on an opposite side of the window 80, and similarly provides access to the cavity 25 such that debris may be cleared out of the cavity 25. For example, a fluid (e.g., compressed air, water, oil, lubricant, etc.) may be introduced into the first window 80 and released from the second window 85 to flush debris out that is positioned within the handle 10.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges or geometric relationships provided. Accordingly, these terms should be interpreted as indicating that insubstantial or inconsequential modifications or alterations of the subject matter described and claimed are considered to be within the scope of the invention as recited in the appended claims.

What is claimed is:

1. A hand tool, comprising:
a handle including:
an opening at a first end of the handle, the opening extending into the handle; and
a first plurality of projections positioned within the opening;
a driver positioned within the opening and including a second plurality of projections configured to interface with the first plurality of projections, wherein the driver is configured to translate along an axis between:
a first position, wherein the first plurality of projections interface with the second plurality of projections while the driver is in the first position such that the driver is prevented from rotating relative to the handle about the axis while the driver is in the first position; and
a second position, wherein the driver is configured to rotate about the axis while the driver is in the second position; and
a spring positioned within the opening and configured to bias the driver towards the second position.

2. The hand tool of claim 1, further comprising a stopper extending into the opening and configured to engage a shoulder of the driver when the driver is in the second position and prevent the driver from extending beyond the second position.

3. The hand tool of claim 2, wherein the stopper extend into the opening in a direction perpendicular to the axis.

4. The hand tool of claim 2, wherein the shoulder is a first shoulder and the stopper is configured to engage a second shoulder in the driver and prevent the driver from extending beyond the second position.

5. The hand tool of claim 1, wherein the driver includes a bit opening configured to receive a bit.

6. The hand tool of claim 1, wherein the driver includes a bit at an end of the driver opposite the second plurality of projections.

7. The hand tool of claim 1, wherein the first plurality of projections are integrally formed with the handle.

8. The hand tool of claim 1, wherein the opening is a first opening and the handle comprises a second opening extending into the first opening, the second opening being positioned between the first plurality of projections and the first opening.

9. The hand tool of claim 8, wherein the second plurality of projections are exposed via the second opening while the driver is in the second position.

10. A ratcheting mechanism, comprising:
a body including:
an opening at a first end of the body, the opening extending into the body to define a cavity; and
a first projection positioned within the cavity opposite the first end of the body;
a driver positioned within the cavity and including a second projection configured to interface with the first projection, wherein the driver is configured to translate between:
a first position, wherein the first projection interfaces with the second projection while the driver is in the first position such that the driver is prevented from rotating within the cavity with respect to the body; and
a second position, wherein the driver is configured to rotate within the cavity with respect to the body while the driver is in the second position; and
a spring positioned within the cavity and configured to bias the driver towards the second position.

11. The ratcheting mechanism of claim 10, wherein the body is integrally formed with a handle of a hand tool.

12. The ratcheting mechanism of claim 10, wherein the body includes a first plurality of projections, including the first projection, and the driver includes a second plurality of projections, including the second projection.

13. The ratcheting mechanism of claim 10, wherein the first projection includes a first sidewall and a second sidewall that converge to a point and define a tooth angle.

14. The ratcheting mechanism of claim 13, wherein the tooth angle is between 80 degrees and 100 degrees.

15. The ratcheting mechanism of claim 10, wherein the first projection is fixed relative to the body.

16. A tool, comprising:
a handle including:
an opening at a first end of the handle, the opening extending into the handle to define a cavity; and
a first plurality of projections positioned within the cavity opposite the first end of the handle;
a driver positioned within the cavity and including a second plurality of projections configured to interface with the first plurality of projections, wherein the driver is configured to translate between:
a first position, wherein the first plurality of projections interface with the second plurality of projections while the driver is in the first position such that the driver is prevented from rotating in a first direction within the cavity with respect to the handle; and
a second position, wherein the driver is configured to rotate in the first direction within the cavity with respect to the handle while the driver is in the second position.

17. The tool of claim 16, wherein the first plurality of projections are fixed relative to the handle.

18. The tool of claim 16, wherein the driver is prevented from rotating in a second direction, opposite the first direction, while the driver is in the first position.

19. The tool of claim 18, wherein the driver is configured to rotate in the second direction while the driver is in the second position.

20. The tool of claim 16, wherein the driver is biased towards the second position.
